(19) United States
(12) Patent Application Publication
(10) Pub. No.: US 2014/0165676 A1
(43) Pub. Date: Jun. 19, 2014

(54) LOCK DEVICE, CONTROLLER, AND ELECTRIC KEY SYSTEM

(71) Applicants: TOYOTA JIDOSHA KABUSHIKI KAISHA, Aichi-ken (JP); KABUSHIKI KAISHA TOKAI RIKA DENKI SEISAKUSHO, Aichi (JP)

(72) Inventors: Tomohiro INOUE, Aichi (JP); Koichi KOJIMA, Toyota-shi (JP)

(73) Assignees: TOYOTA JIDOSHA KABUSHIKI KAISHA, Aichi-ken (JP); KABUSHIKI KAISHA TOKAI RIKA DENKI SEISAKUSHO, Aichi (JP)

(21) Appl. No.: 14/103,295

(22) Filed: Dec. 11, 2013

(30) Foreign Application Priority Data
Dec. 13, 2012 (JP) 2012-272502

(51) Int. Cl. E05B 77/44

(52) U.S. Cl. CPC E05B 77/44
USPC 70/256; 70/237

(57) ABSTRACT

A power port lock device locks a locking subject to restrict removal of a charge cable from a power port arranged in a vehicle or restrict connection of the charge cable to the power port. The lock device includes a lock mechanism that locks and unlocks the locking subject. A door monitoring unit monitors a locking state of a vehicle door. A detection unit detects an operation to a door locking-unlocking unit which is operated to lock or unlock the vehicle door. A lock control unit controls operation of the lock mechanism based on a monitoring result of the door monitoring unit and a detection result of the detection unit.

### CROSS-REFERENCE TO RELATED APPLICATIONS

This application is based upon and claims the benefit of priority from prior Japanese Patent Application No. 2012-272502, filed on Dec. 13, 2012, the entire contents of which are incorporated herein by reference.

### BACKGROUND

The present invention relates to a lock device for locking a locking subject.

A vehicle that emits less carbon dioxide, such as a plugin hybrid electric vehicle and an electric vehicle, includes a battery and a power port. The battery drives a motor that drives the vehicle, and the power port is used to charge the battery. The user connects a charge cable, which extends from a charging facility, to the power port to charge the battery with the power supplied from the charging facility. A charge cable lock device may be used to lock the charge cable when charging the battery and prevent theft of the charge cable. Japanese Laid-Open Patent Publication No. 2009-081917 describes an example of such a charge cable lock device.

### SUMMARY

The charge cable lock device of the '917 publication functions in cooperation with a door lock device of a vehicle. For example, when a vehicle door is unlocked, the charge cable lock device of the '917 publication performs an unlocking operation. Thus, when locking or unlocking the vehicle door, the charge cable lock device functions even though there is no need to charge the battery. Unnecessary operations of the charge cable lock device may shorten the product life.

It is an object of the present invention to reduce unnecessary operations of the lock device.

One aspect of the present invention is a lock device for locking a locking subject with a lock mechanism to restrict removal of a charge cable from a power port arranged in a vehicle or restrict connection of the charge cable to the power port. The lock device includes a door monitoring unit that monitors a locking state of a vehicle door. A detection unit detects an operation on a door locking-unlocking unit which is operated to lock or unlock the vehicle door. A lock control unit controls at least one of locking and unlocking of the locking subject based on a monitoring result of the door monitoring unit and a detection result of the detection unit.

Another aspect of the present invention is a controller coupled to a power port lock mechanism to control the power port lock mechanism, wherein the power port lock mechanism locks an power port arranged in a vehicle in response to a power port lock drive signal to restrict removal of a charge cable from the power port or restrict connection of the charge cable to the power port, and the power port lock mechanism unlocks the power port in response to a power port unlock drive signal to permit removal of the charge cable from the power port or permit connection of the charge cable to the power port. The controller includes instructions configured to receive a door lock state signal indicating that a vehicle door is locked, a door unlock state signal indicating that the vehicle door is unlocked, a vehicle door locking operation notification signal, and a vehicle door unlocking operation notification signal; instructions configured to provide the power port lock mechanism with the power port lock drive signal when the door lock state signal and the vehicle door locking operation notification signal, which follows the door lock state signal, are received; and instructions configured to provide the power port lock mechanism with the power port unlock drive signal when the door unlock state signal and the vehicle door unlocking operation notification signal, which follows the door unlock state signal, are received.

Further aspect of the present invention is an electronic key system including an electronic key that performs wireless communication; a verification ECU that verifies the electronic key through wireless communication; a power port lock mechanism responsive to a power port lock drive signal and a power port unlock drive signal; and a controller coupled to the power port lock mechanism to control the power port lock mechanism. The power port lock mechanism locks a power port arranged in a vehicle in accordance with the power port lock drive signal to restrict removal of a charge cable from the power port or restrict connection of the charge cable to the power port, and the power port lock mechanism unlocks the power port in accordance with the power port unlock drive signal to permit removal of the charge cable from the power port or permit connection of the charge cable to the power port. The controller includes instructions configured to receive a door lock state signal indicating that a vehicle door is locked, a door unlock state signal indicating that the vehicle door is unlocked, a vehicle door locking operation notification signal, and a vehicle door unlocking operation notification signal, instructions configured to provide the power port lock mechanism with the power port lock drive signal when, after the verification ECU verifies the electronic key, the door lock state signal and the vehicle door locking operation notification signal, which follows the door lock state signal, are received, and instructions configured to provide the power port lock mechanism with the power port unlock drive signal when, after the verification ECU verifies the electronic key, the door unlock state signal and the vehicle door unlocking operation notification signal, which follows the door unlock state signal, are received.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of a vehicle including a lock device of a first embodiment;

FIG. 2 is a schematic plan view of the vehicle;

FIG. 3 is a schematic view illustrating a locking operation of the lock device in the first embodiment;

FIG. 4 is a schematic view illustrating an unlocking operation of the lock device in the first embodiment;

FIG. 5A is a schematic diagram illustrating a locking operation of the lock device in a second embodiment;

FIG. 5B is a perspective view of a passenger compartment;

FIG. 6 is a schematic diagram illustrating an unlocking operation of the lock device in the second embodiment;

FIG. 7 is a schematic view illustrating a locking operation of the lock device in a third embodiment;

FIG. 8 is a schematic view illustrating an unlocking operation of the lock device in the third embodiment;

FIG. 9 is a schematic view illustrating a locking operation of the lock device in a fourth embodiment;

FIG. 10 is a schematic view illustrating an unlocking operation of the lock device in the fourth embodiment;

FIG. 11A is a schematic diagram showing a lid unlocked by a lock device of the further example, and

FIG. 11B is a schematic diagram showing the lid locked by the lock device of the further example.

### DESCRIPTION OF EMBODIMENTS

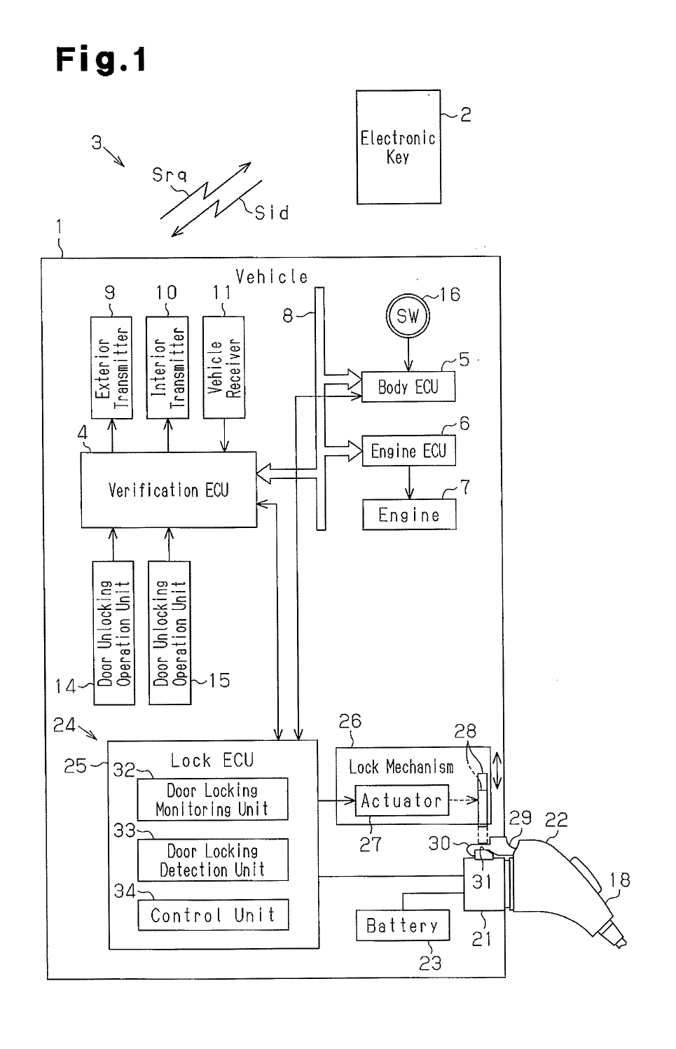

A first embodiment of a lock device will now be described with reference to FIGS. 1 to 4.

Referring to FIG. 1, a vehicle 1 includes an electronic key system 3 that performs wireless communication with an electronic key 2, which has an electronic key ID, to execute electronic key verification. The electronic key system 3 is, for example, an operation-free key system that executes ID verification (smart verification) by performing short-range wireless communication (communication distance of several meters), which is initiated by the vehicle 1. The electronic key 2 may be referred to as a remote control key device capable of transmitting the electronic key ID through wireless communication.

The vehicle 1 includes a verification electronic control unit (ECU) 4 that verifies the electronic key ID, a body ECU 5 that manages the power supplied to onboard electric devices, and an engine ECU 6 that controls the engine 7. An in-vehicle bus 8 connects the ECUs 4, 5, and 6. The verification ECU 4 includes a memory that stores the electronic key ID of the electronic key 2 that is registered to the vehicle 1. The verification ECU 4 is connected to an exterior transmitter 9, which transmits radio waves on the low frequency (LF) band out of the vehicle 1, an interior transmitter 10, which transmits radio waves on the LF band in the vehicle 1, and a vehicle receiver 11, which receives radio waves on the ultrahigh frequency (UHF) band.

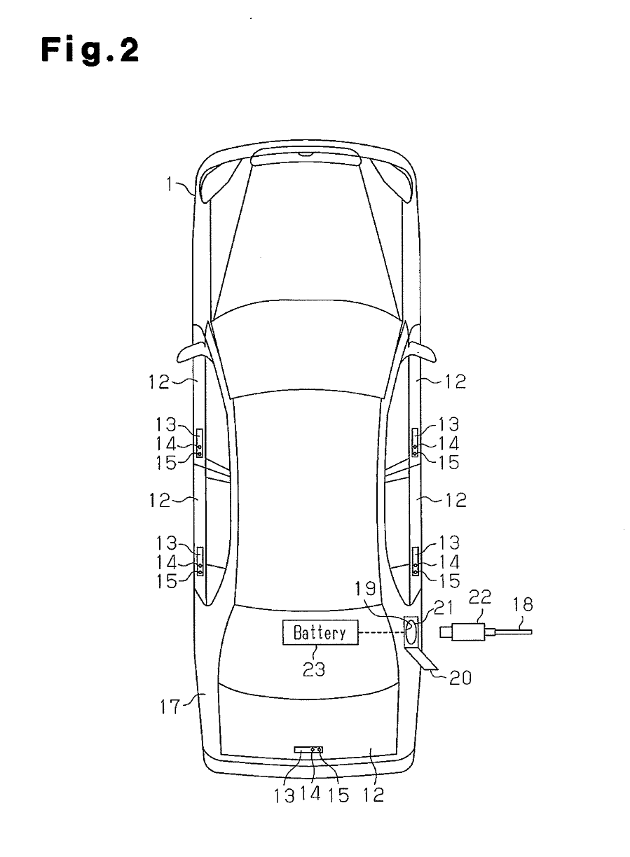

As shown in FIG. 2, vehicle doors 12 each include an outer door handle 13. Each outer door handle 13 includes a door locking operation unit 14 operated by a user to lock the vehicle doors 12. The door locking operation unit 14 may be, for example, a push-type momentary lock button. The outer door handle 13 also includes a door unlocking operation unit 15 operated by the user to unlock the vehicle doors 12. The door unlocking operation unit 15 may be, for example, a push-type momentary unlock button or a touch sensor. The door locking operation unit 14 and the door unlocking operation unit 15 may be arranged on, for example, at least one of the driver door, the passenger door, the right rear door, the left rear door, and the trunk door. The door locking operation unit 14 and the door unlocking operation unit 15 function as a door locking-unlocking unit.

Referring to FIG. 1, when the vehicle 1 is parked or stopped, the exterior transmitter 9 transmits, through wireless communication, a request signal Srq out of the vehicle 1 to request for an ID reply. The electronic key 2 that receives the request signal Srq returns, through wireless communication, an ID signal Sid. The request signal Srq is, for example, a wireless signal on the LF band, and the ID signal Sid is, for example, a wireless signal on the UHF band. The ID signal Sid includes the electronic key ID, which is unique to the electronic key 2. When the verification ECU 4 receives the ID signal Sid with the vehicle receiver 11, the verification ECU 4 executes ID verification (vehicle exterior smart verification) on the electronic key ID in the ID signal Sid. When accomplishing the verification, the verification ECU 4 permits or performs the locking or unlocking of the vehicle doors 12. For example, if the doors 12 are unlocked when vehicle exterior smart verification has been accomplished, the operation of a door locking operation unit 14 locks the vehicle doors 12. If the vehicle doors 12 are locked when vehicle exterior smart verification has been accomplished, the operation of a door unlocking operation unit 15 unlocks the vehicle doors 12. If the vehicle doors 12 are locked when a door unlocking operation unit 15 detects the touching of the corresponding outer door handle 13, the vehicle door 12 is unlocked.

When the electronic key 2 is located in the vehicle 1, the interior transmitter 10 transmits a request signal Srq inside the vehicle 1. Then, ID verification (vehicle interior smart verification) is executed through the same procedures as the vehicle exterior smart verification. When vehicle interior smart verification is accomplished and an engine switch 16 arranged near the driver seat is operated, power activation (engine starting) of the vehicle 1 is permitted.

Referring to FIG. 2, the vehicle 1 includes a battery 23 for a plugin hybrid electric vehicle or an electric vehicle. The vehicle body 17 includes a power port 19 arranged in, for example, a side wall. A lid 20 closes the power port 19. An inlet 21, which includes a power reception connection terminal, is arranged in the power port 19. A power plug 22, which includes a power supplying connection terminal, is arranged on the distal end of the charge cable 18. The power plug 22 is connected to the inlet 21 to charge the battery 23. The charge cable 18 or the power plug 22 is an example of a locking subject.

Referring to FIG. 1, the power port 19 includes a lock device 24 that restricts removal of the charge cable 18 from the inlet 21. The lock device 24 includes a lock mechanism 26 and a lock ECU 25, which controls the operation of the lock mechanism 26. The lock mechanism 26 includes a lock pin 28 and an actuator 27. The lock pin 28 is moved between a lock position where the lock pin 28 locks the charge cable 18 and an unlock position where the lock pin 28 unlocks the charge cable 18. The actuator 27 serves as a drive source that moves the lock pin 28. Electric wires connect the lock ECU 25 to the verification ECU 4 and the body ECU 5. The lock ECU 25 controls and drives the actuator 27 to move the lock pin to the lock position or the unlock position. The lock pin 28 is one example of a lock member. The lock device 24 may be referred to as a charge cable lock device or a power port lock device. The lock mechanism 26 may be referred to as a charge cable lock mechanism or a power port lock mechanism.

When the charge cable 18 is connected to the inlet 21, an urging member (not shown) pivots a lock arm 29 of the power plug 22 to a close position. A hook 30 on the distal end of the lock arm 29 is hooked to a catch 31 on the inlet 21 so that the charge cable 18 cannot be separated from the inlet 21. The lock device 24 locks the charge cable 18 to the inlet 21 by holding the hook 30 of the lock arm 29 from above with the lock pin 28 that is located at a lock position.

The lock ECU 25 includes a monitoring unit 32, which monitors the lock state of the vehicle doors 12, and a door locking detection unit 33, which detects when the door locking operation unit 14 or the door unlocking operation unit 15 is operated. The monitoring unit 32 monitors the present door lock state based on a door lock state notification signal N_{LS} or a door unlock state notification signal N_{ULS} provided from the body ECU 5. The door locking detection unit 33 detects when a door locking operation unit 14 or a door unlocking operation unit 15 is operated based on a door locking operation notification signal N_{LO} or a door unlocking operation notification signal N_{ULO} provided from the verification ECU 4. The monitoring unit 32 is also referred to as a door monitoring unit. The detection unit 33 is also referred to as door locking operation detection unit.

The lock ECU 25 includes a lock control unit 34 that provides the lock mechanism 26 with a drive signal for controlling the operation of the lock mechanism 26 based on the monitoring result of the monitoring unit 32 and the detection result of the door locking detection unit 33. The drive signal is a lock drive signal D_{L} (also referred to as a power port lock drive signal) or an unlock drive signal D_{UL} (also referred to as a power port unlock drive signal). For example, when the lock control unit 34 receives a door lock state notification signal N_{LS} and a door locking operation notification signal N_{LO}, which indicates that a door locking operation unit 14 has been operated, the lock control unit 34 provides the lock mechanism 26 with a lock drive signal D_{L} and locks the charge cable 18. When the lock control unit 34 receives a door unlock state notification signal N_{ULS} and a door unlocking operation notification signal N_{ULO}, which indicates that a door unlocking operation unit 15 has been operated, the lock control unit 34 provides the lock mechanism 26 with an unlock drive signal D_{UL} and unlocks the charge cable 18.

The operation of the lock device 24 will now be described.

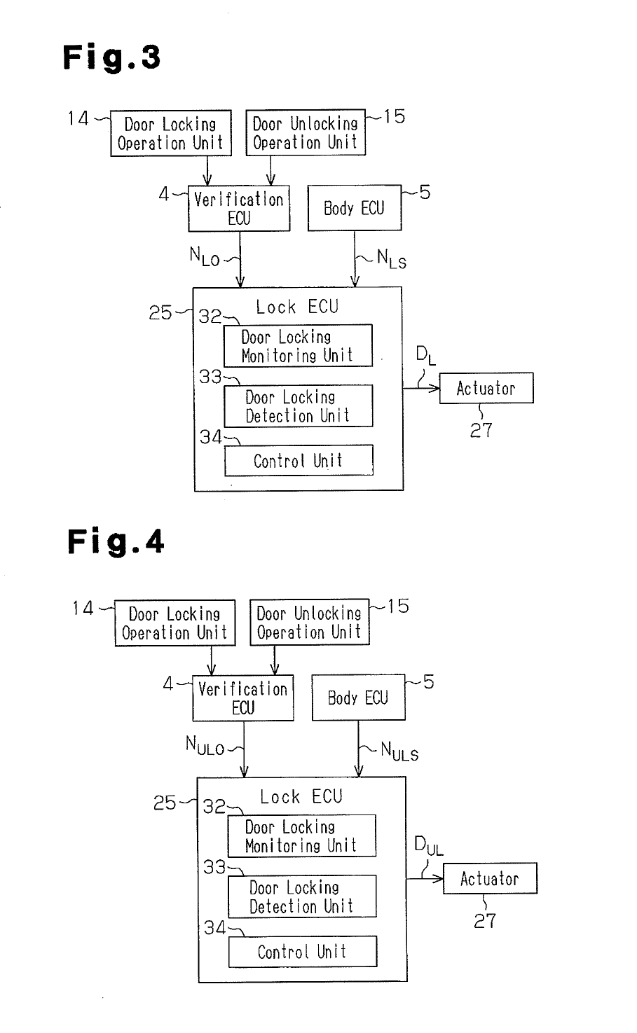

Referring to FIG. 3, when the body ECU 5 detects that the vehicle doors 12 have been locked with a switch or sensor that detects the lock state of the vehicle doors 12, the body ECU 5 provides the lock ECU 25 with a door lock state notification signal N_{LS}. Based on the door lock state notification signal N_{LS}, the monitoring unit 32 of the lock ECU 25 determines that the vehicle doors 12 are locked. In addition to detecting when the locking state of the doors 12 is switched by an operation performed with the operation-free key system, the monitoring unit 32 may detect when the locking state of the doors 12 is switched by a different system or device.

To switch the charge cable lock mechanism 26 from an unlock state to a lock state, the user operates the door locking operation unit 14 when the doors 12 are locked. For example, the user operates a door locking operation unit 14 to lock the vehicle doors 12. Then, the user operates the door locking operation unit 14 again to switch the lock mechanism 26 to a lock state. Under a situation in which the doors 12 are locked, when the verification ECU 4 detects further operation of the door locking operation unit 14, the verification ECU 4 provides the lock ECU 25 with a door locking operation notification signal N_{LO}. The door locking detection unit 33 of the lock ECU 25 acquires the door locking operation notification signal N_{LO}.

When the lock control unit 34 receives a door lock state notification signal N_{LS}, which indicates that the vehicle doors 12 have been locked, from the body ECU 5 and the following door locking operation notification signal N_{LO} from the verification ECU 4, the lock control unit 34 provides the actuator 27 with a lock drive signal D_{L} and moves the lock pin 28 to the lock position (double-dashed line in FIG. 1). The lock pin 28 is engaged with the charge cable 18 that is connected to the inlet 21. This locks the charge cable 18 to the inlet 21. Thus, an unauthorized person cannot remove the charge cable 18 from the inlet 21.

Referring to FIG. 4, when the body ECU 5 detects that the vehicle doors 12 have been unlocked with a switch or sensor that detects the unlock state of the vehicle doors 12, the body ECU 5 provides the lock ECU 25 with a door unlock state notification signal N_{ULS}. Based on the door unlock state notification signal N_{ULS}, the monitoring unit 32 of the lock ECU 25 determines that the vehicle doors 12 are unlocked. In addition to detecting when the unlock state of the doors 12 is switched by an operation performed with the operation-free key system, the monitoring unit 32 may detect when the unlock state of the doors 12 is switched by a different system or device.

To switch the charge cable lock mechanism 26 from a lock state to an unlock state, the user operates the door unlocking operation unit 15 when the doors 12 are unlocked. For example, the user operates a door locking operation unit 14 to lock the vehicle doors 12. Then, the user operates the door unlocking operation unit 15 again to switch the lock mechanism 26 to an unlock state. Under a situation in which the doors 12 are unlocked, when the verification ECU 4 detects further operation of the door unlocking operation unit 15, the verification ECU 4 provides the lock ECU 25 with a door unlocking operation notification signal N_{ULO}. The door locking detection unit 33 of the lock ECU 25 acquires the door unlocking operation notification signal N_{ULO}.

When the lock control unit 34 receives a door unlock state notification signal N_{ULS}, which indicates that the vehicle doors 12 have been unlocked, from the body ECU 5 and the following door unlocking operation notification signal N_{ULO} from the verification ECU 4, the lock control unit 34 provides the actuator 27 with an unlock drive signal D_{UL}, and moves the lock pin 28 to the unlock position (double-dashed line in FIG. 1). The lock pin 28 is disengaged from the charge cable 18 to unlock the charge cable 18. This allows the user to remove the unlocked charge cable 18 from the inlet 21.

The first embodiment has the advantages described below.

(1) If the door locking operation unit 14 is operated when the vehicle doors 12 are locked, the charge cable lock device 24 is switched to a lock state. If the door unlocking operation unit 15 is operated when the vehicle doors 12 are unlocked, the charge cable lock device 24 is switched to an unlock state. If the door locking operation unit 14 is operated when the vehicle doors 12 are unlocked, the vehicle doors 12 are locked but the charge cable lock device 24 is not switched to a lock state. If the door unlocking operation unit 15 is operated when the vehicle doors 12 are locked, the vehicle doors 12 are unlocked but the charge cable lock device 24 is not switched to an unlock state. Accordingly, unnecessary operations of the charge cable lock device 24 are reduced. In this manner, the charge cable lock device 24 performs locking and unlocking operations only when necessary.

(2) The user may switch the state of the charge cable lock device 24 by operating the conventional door locking operation unit 14 and the door unlocking operation unit 15 of the vehicle 1. Thus, there is no need for a dedicated operation member to be newly added to the vehicle 1 to switch the charge cable lock device 24 between lock and unlock states.

(3) The door locking operation unit 14 and the door unlocking operation unit 15 are arranged outside the vehicle 1. This allows for the user to lock and unlock the charge cable 18 outside the vehicle 1 by operating the door locking operation unit 14 and the door unlocking operation unit 15.

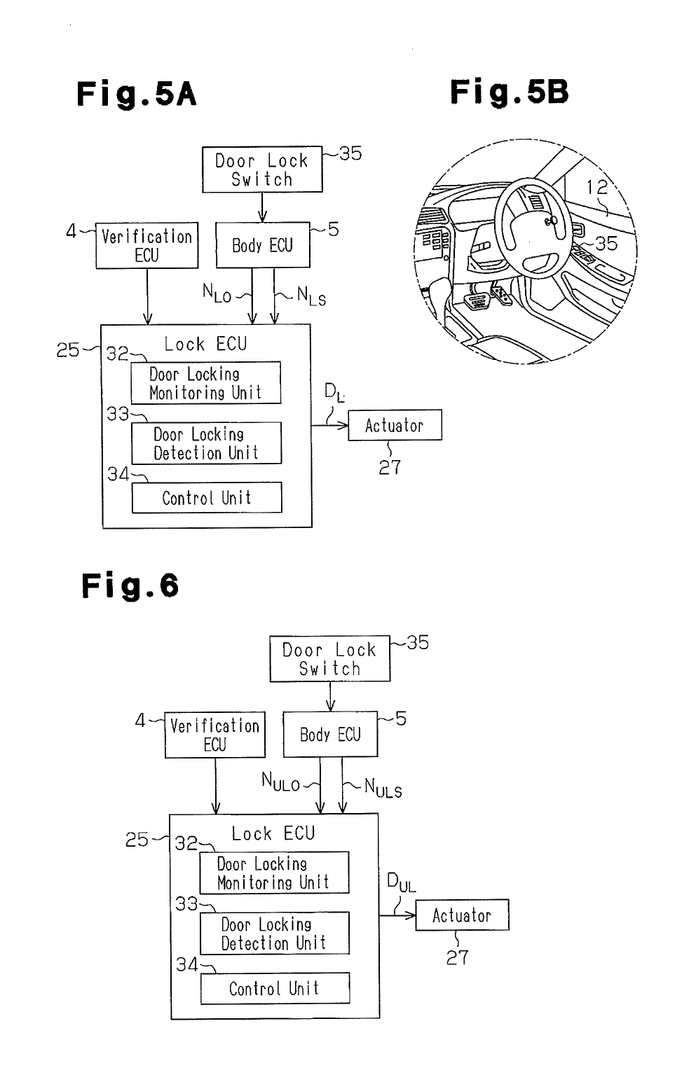

A second embodiment will now be described with reference to FIGS. 5 and 6 focusing on differences from the first embodiment.

Referring to FIG. 5B, in the vehicle 1, that is, in the passenger compartment, a vehicle door 12 includes an inner wall provided with a door lock switch 35 operated to lock and unlock the vehicle door 12. The door lock switch 35 may be, for example, a seesaw switch that locks the vehicle door 12 when one end is pushed and unlocks the vehicle door 12 when the other end is pushed. In another example, the door lock switch 35 is formed by two separate switches, namely, a lock switch and an unlock switch. The door lock switch 35 is connected to the body ECU 5. The body ECU 5 locks or unlocks the vehicle door 12 when the door lock switch 35 is operated. The door lock switch 35 functions as a door locking-unlocking unit.

The body ECU 5 provides the lock ECU 25 with a notification signal corresponding to the operation of the door lock switch 35. For example, when the body ECU 5 detects that a locking operation has been performed on the door lock switch 35, the body ECU 5 provides a door locking operation notification signal N_{LO} to the lock ECU 25. When the body ECU 5 detects that an unlocking operation has been performed on the door lock switch 35, the body ECU 5 provides a door unlocking operation notification signal N_{ULO} to the lock ECU 25. The door locking detection unit 33 of the lock ECU 25 acquires the door locking operation notification signal N_{LO} or the door unlocking operation notification signal N_{ULO} from the body ECU 5.

The lock control unit 34 controls the operation of the lock mechanism 26 in accordance with the locking state of the vehicle door 12 and the operation of the door lock switch 35. For example, if a locking operation is performed on the door lock switch 35 in the passenger compartment when the door 12 is locked, the lock mechanism 26 is switched to a lock state. If an unlocking operation is performed on the door lock switch 35 in the passenger compartment when the door 12 is unlocked, the lock mechanism 26 is switched to an unlock state.

Referring to FIG. 5A, to switch the charge cable 18 from an unlock state to a lock state, the user performs a locking operation on the door lock switch 35 in the passenger compartment when the door 12 is locked. If the body ECU 5 detects that a locking operation has been performed on the door lock switch 35 when the door 12 is locked, the body ECU 5 provides a door locking operation notification signal N_{LO} to the lock ECU 25. When the lock control unit 34 receives a door lock state notification signal N_{LS} from the body ECU 5 indicating that the vehicle door 12 has been locked and a following door locking operation notification signal N_{LO}, the lock control unit 34 provides the actuator 27 with a lock drive signal D_{L} and locks the charge cable 18.

Referring to FIG. 6, to switch the charge cable 18 from a lock state to an unlock state, the user performs an unlocking operation on the door lock switch 35 in the passenger compartment when the door 12 is unlocked. If the body ECU 5 detects that an unlocking operation has been performed on the door lock switch 35 when the door 12 is locked, the body ECU 5 provides a door unlocking operation notification signal N_{ULO} to the lock ECU 25. When the lock control unit 34 receives a door unlock state notification signal N_{ULS} from the body ECU 5 indicating that the vehicle door 12 has been unlocked and a following door unlocking operation notification signal N_{ULO}, the lock control unit 34 provides the actuator 27 with an unlock drive signal D_{UL} and unlocks the charge cable 18.

If a locking operation is performed on the door lock switch 35 when the vehicle door 12 is unlocked, the vehicle door 12 is locked but the charge cable lock device 24 is not switched to a lock state. If an unlocking operation is performed on the door lock switch 35 when the vehicle door 12 is locked, the vehicle door 12 is unlocked but the charge cable lock device 24 is not switched to an unlock state.

In addition to advantages (1) and (2) of the first embodiment, the second embodiment has the following advantage.

(4) The user may use the door lock switch 35, which is arranged in the passenger compartment, to switch the charge cable lock device 24 between lock and unlock states.

A third embodiment will now be described focusing on differences from the first embodiment.

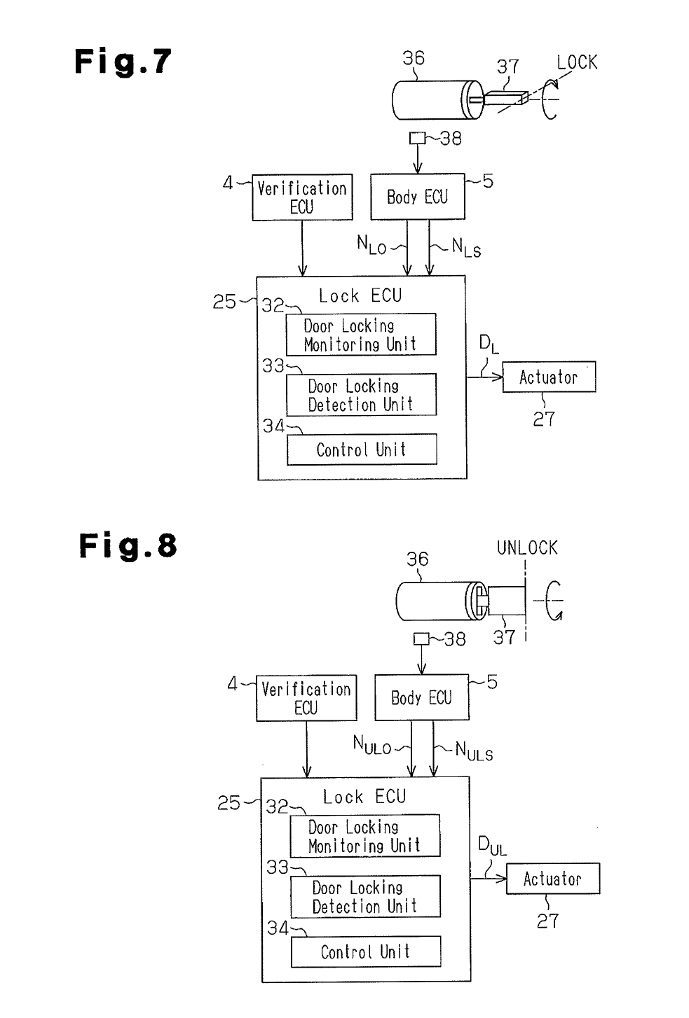

Referring to FIGS. 7 and 8, a vehicle door 12 has an outer wall including a key cylinder 36. The user inserts a mechanical key 37 into the key cylinder 36 and turns the mechanical key 37 to rotate the key cylinder 36 to a lock position (shown in FIG. 7) where the key cylinder 36 locks the door 12 and an unlock position (shown in FIG. 8) where the key cylinder 36 unlocks the door 12. The key cylinder 36 functions as a door locking-unlocking unit.

A cylinder position detection unit 38 detects the rotational position of the key cylinder 36 and provides the detection result to the body ECU 5. The cylinder position detection unit 38 is formed by, for example, a microswitch, a magnetic sensor, an optical sensor, or the like. When the key cylinder 36 is located at the lock position, the body ECU 5 provides the lock ECU 25 with a door locking operation notification signal N_{LO}. When the key cylinder 36 is located at the unlock position, the body ECU 5 provides the lock ECU 25 with a door unlocking operation notification signal N_{ULO}. The door locking detection unit 33 of the lock ECU 25 acquires the door locking operation notification signal N_{LO} or the door unlocking operation notification signal N_{ULO} from the body ECU 5.

The lock control unit 34 controls the operation of the lock mechanism 26 in accordance with the locking state of the vehicle door 12 and an operation performed on the key cylinder 36. For example, if the key cylinder 36 is rotated to the lock position when the door 12 is locked, the lock mechanism 26 is switched from an unlock state to a lock state. If the key cylinder 36 is rotated to the unlock position when the door 12 is unlocked, the lock mechanism 26 is switched from a lock state to an unlock state.

Referring to FIG. 7, to lock the charge cable 18, the user rotates the key cylinder 36 to the lock position with the mechanical key 37 when the door 12 is locked. If the body ECU 5 detects that the key cylinder 36 has been rotated to the lock position when the door 12 is locked, the body ECU 5 provides a door locking operation notification signal N_{LS} to the lock ECU 25. When the lock control unit 34 receives a door lock state notification signal N_{LS} from the body ECU 5 indicating that the vehicle door 12 has been locked and a following door locking operation notification signal N_{LO}, the lock control unit 34 provides the actuator 27 with a lock drive signal D_{L} and locks the charge cable 18.

Referring to FIG. 8, to unlock the charge cable 18, the user rotates the key cylinder 36 to the unlock position with the mechanical key 37 when the door 12 is unlocked. If the body ECU 5 detects that the key cylinder 36 has been rotated to the unlock position when the door 12 is unlocked, the body ECU 5 provides a door unlocking operation notification signal N_{ULO} to the lock ECU 25. When the lock control unit 34 receives a door unlock state notification signal N_{ULS} from the body ECU 5 indicating that the vehicle door 12 has been unlocked and a following door unlocking operation notification signal N_{ULO}, the lock control unit 34 provides the actuator 27 with an unlock drive signal D_{UL} and unlocks the charge cable 18.

In addition to advantages (1) and (2) of the first embodiment, the third embodiment has the following advantage.

(5) Even when radio wave interference occurs or the battery of the electronic key 2 is drained, the user may lock or unlock the charge cable 18.

A fourth embodiment will now be described focusing on differences from the first embodiment.

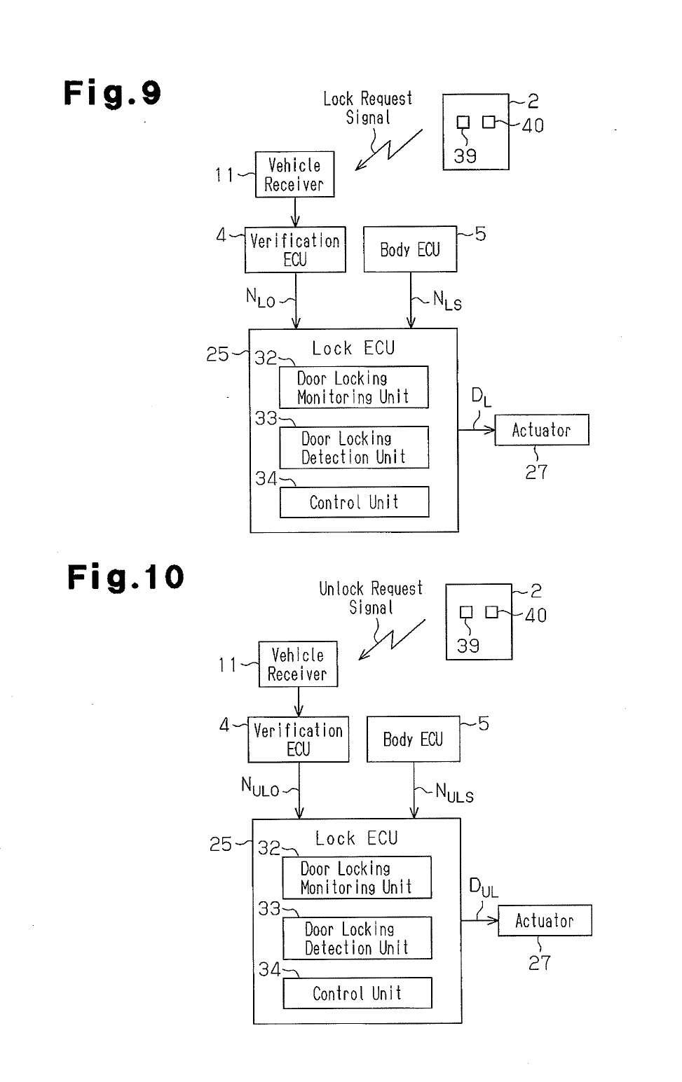

In the example shown in FIGS. 9 and 10, the electronic key system 3 includes a wireless key system. The wireless key system allows for the vehicle 1 to be operated from a remote location by performing short-range wireless communication (communication distance of several meters), which is initiated by a wireless signal transmitted from the electronic key 2. The electronic key 2 includes a lock button 39, which may be operated to lock the vehicle door 12 from a remote location, and an unlock button 40, which may be operated to unlock the vehicle door 12 from a remote location. When the lock button 39 or the unlock button 40 is operated, the electronic key 2 transmits, through wireless communication, a lock request signal or an unlock request signal to the vehicle 1. The request signals may be wireless signals on the UHF band. The lock button 39 and the unlock button 40 of the electronic key form a door locking-unlocking unit.

The verification ECU 4 receives a request signal from the electronic key 2 with the vehicle receiver 11. When the verification ECU 4 receives a lock request signal from the electronic key 2, the verification ECU 4 provides the lock ECU 25 with a door locking operation notification signal N_{LO}. When the verification ECU 4 receives an unlock request signal from the electronic key 2, the verification ECU 4 provides the lock ECU 25 with a door unlocking operation notification signal N_{ULO}. The door locking detection unit 33 of the lock ECU 25 acquires the door locking operation notification signal N_{LO} or the door unlocking operation notification signal N_{ULO}.

The lock control unit 34 controls the operation of the lock mechanism 26 in accordance with the locking state of the vehicle door 12 and the operation performed on the electronic key 2 (operation of lock button 39 or unlock button 40). For example, if the lock button 39 of the electronic key 2 is operated when the door 12 is locked, the lock mechanism 26 is switched from an unlock state to a lock state. If the unlock button 40 of the electronic key 2 is operated when the door 12 is unlocked, the lock mechanism 26 is switched from a lock state to an unlock state.

Referring to FIG. 9, to lock the charge cable 18, the user operates the lock button 39 of the electronic key 2 when the door 12 is locked. When the lock button 39 is operated, the electronic key 2 transmits, through wireless communication, a lock request signal. The lock request signal includes the electronic key ID and a lock command.

If the verification ECU 4 receives the lock request signal when the door 12 is locked, the verification ECU 4 provides the lock ECU 25 with a door locking operation notification signal N_{LO}. When the lock control unit 34 receives a door lock state notification signal N_{LS} from the body ECU 5 indicating that the vehicle door 12 has been locked and a following door locking operation notification signal N_{LO} from the verification ECU 4, the lock control unit 34 provides the actuator 27 with a lock drive signal D_{L} and locks the charge cable 18.

Referring to FIG. 10, to unlock the charge cable 18, the user operates the unlock button 40 of the electronic key 2 when the door 12 is unlocked. When the unlock button 40 is operated, the electronic key 2 transmits, through wireless communication, an unlock request signal. The unlock request signal includes the electronic key ID and a lock command.

If the verification ECU 4 receives the unlock request signal when the door 12 is unlocked, the verification ECU 4 provides the lock ECU 25 with a door unlocking operation notification signal N_{ULO}. When the lock control unit 34 receives a door unlock state notification signal N_{ULS} from the body ECU 5 indicating that the vehicle door 12 has been unlocked and a following door unlocking operation notification signal N_{ULO} from the verification ECU 4, the lock control unit 34 provides the actuator 27 with an unlock drive signal D_{UL}, and unlocks the charge cable 18.

If the user operates the lock button 39 of the electronic key 2 when the vehicle door 12 is unlocked, the vehicle door 12 is locked but the charge cable lock device 24 is not switched to a lock state. If the user operates the unlock button 40 of the electronic key 2 when the vehicle door 12 is locked, the vehicle door 12 is unlocked but the charge cable lock device 24 is not switched to the unlock state.

In addition to advantages (1) and (2) of the fourth embodiment, the fourth embodiment has the following advantage.

(6) The charge cable 18 is switched between lock and unlock states from a remote location by operating the electronic key 2. This allows for the user to switch the charge cable lock device 24 between lock and unlock states from a location separated from the vehicle 1.

It should be apparent to those skilled in the art that the present invention may be embodied in many other specific forms without departing from the spirit or scope of the invention. Particularly, it should be understood that the present invention may be embodied in the following forms.

In each of the above embodiments, in addition to the monitoring result of the monitoring unit 32 and the detection result of the detection unit 33, the lock control unit 34 may further base the control of the lock mechanism 26 on, for example, the ID verification result of the electronic key system. Further, in addition to the monitoring result of the monitoring unit 32, the lock control unit 34 may further base the control of the lock mechanism 26 on a detection result indicating that the charge cable 18 is connected to the inlet 21.

In each of the above embodiments, the lock control unit 34 may operate the lock mechanism 26 only when receiving a door locking operation notification signal or a door unlocking operation notification signal during a predetermined time from when the vehicle door 12 is locked or unlocked. Preferably, this control is executed with an electronic key system 3 having an automatic locking function.

In each of the above embodiments, the monitoring unit 32 may directly detect a door lock state and a door unlock state without the body ECU 5.

In the second to fourth embodiments, each outer door handle 13 may be provided with a single operation unit. Whenever the operation unit is operated, the vehicle door 12 is switched between lock and unlock states.

In the second embodiment, the door lock switch 35 in the passenger compartment does not have to be arranged on the inner wall of the vehicle door 12 and may be arranged at a different location, such as on a center console.

In the third embodiment, the key cylinder 36 may be arranged in, for example, the glove compartment.

In each of the above embodiments, instead of an operation-free key system or a wireless key system, the electronic key system 3 may be, for example, a near-field wireless communication system. A near field wireless communication system executes ID verification through bidirectional near field wireless communication (communication distance of several centimeters to several tens of centimeters) and may be, for example, an immobilizer system or a near field communication (NFC) system.

In each of the above embodiments, the electronic key system 3 may use radio waves in frequencies other than the LF band and the UHF band.

In each of the above embodiments, the actuator 27 of the lock mechanism 26 is not particularly limited and may be, for example, a motor or a solenoid.

In each of the above embodiments, the lock device 24 may manually perform one of a locking operation and an unlocking operation and automatically perform the other one of the locking operation and the unlocking operation.

In each of the above embodiments, as long as the lock pin 28 moves to the lock position and the unlock position, the lock device 24 may have any structure. For example, the lock pin 28 may be a pivotal cylindrical lock member including a cutout portion. In this case, the cutout portion of the lock member allows for movement of the lock arm 29, and the outer surface of the lock member where the cutout portion is not formed restricts movement of the lock arm 29. In another example, the lock member is a pivotal triangular plate.

An urging member may constantly urge the lock pin 28 to the unlock position. As another example, an urging member may constantly urge the lock pin 28 to the lock position.

The movement of the lock pin 28 may be guided by a projection and a groove. The groove may have an inclined bottom surface. In this case, movement of the lock pin 28 along the groove varies the projection amount of the lock pin 28. The lock position and the unlock position correspond to, for example, a location where the projection amount is relatively large and a location where the projection amount is relatively small.

The lock pin 28 may be directly hooked to the outer surface (housing) of the power plug 22.

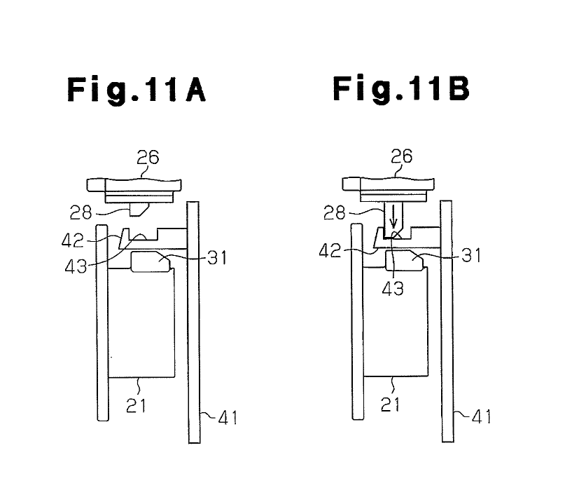

As shown in FIGS. 11A and 11B, the lock device 24 may lock a lid 41 that closes the power port. For example, the lock pin 28 may be engaged with a striker 42 (groove 43), which is arranged on the rear surface of the lid 41, to lock the lid 41 in a closed state. The lid 41 is one example of a locking subject. The lid 41 may be unlocked by operating, for example, a lid opening button (switch) arranged in the vehicle 1. Alternately, when the electronic key system 3 accomplishes ID verification, the lid 41 may be pushed further inward from a closed position to unlock the lid 41.

The lock control unit 34 may check whether the electronic key system 3 has accomplished ID verification before locking the lid 41.

In each of the above embodiments, the lock device 24 may be configured to lock the charge cable 18 when the charge cable 18 is connected to the inlet, and lock the lid 41 when the charge cable is not connected to the inlet. Preferably, in this case, the charge cable and the lid 41 are locked by the same lock pin 28 and actuator 27.

In each of the above embodiments, the locking subject is not limited to where the charge cable 18 and the vehicle 1 (inlet 21) are connected and may be, for example, where the charge cable 18 and a charging facility (e.g., household or charging station) are connected or both of these connections.

In each of the above embodiments, the lock control unit 34 only needs to execute the control according to the present embodiment for at least one of the locking and unlocking operations.

In some embodiments, the lock ECU 25 may solely function as a controller or be integrated with the verification ECU 4 and or the body ECU 5 to function as a controller. The controller includes computer-readable instructions to be executed by the controller. In some embodiments, the instructions may be stored in a computer-readable storage device, such as a magnetic disk or an optical disc, coupled to, accessed by, or included in the controller.

The above description is intended to be illustrative, and not restrictive. For example, the above-described examples (or one or more aspects thereof) may be used in combination with each other. Inventive subject matter may lie in less than all features of a particular disclosed embodiment and may be modified within the scope and equivalence of the appended claims.

1. A lock device for locking a locking subject with a lock mechanism to restrict removal of a charge cable from a power port arranged in a vehicle or restrict connection of the charge cable to the power port, the lock device comprising:
a door monitoring unit that monitors a locking state of a vehicle door;
a detection unit that detects an operation to a door locking-unlocking unit which is operated to lock or unlock the vehicle door; and
a lock control unit that controls at least one of locking and unlocking of the locking subject based on a monitoring result of the door monitoring unit and a detection result of the detection unit.

2. The lock device according to claim 1, wherein the lock control unit is configured to
lock the locking subject if the vehicle door is locked when a locking operation is performed on the door locking-unlocking unit that is arranged outside the vehicle door, and
unlock the locking subject if the vehicle door is unlocked when an unlocking operation is performed on the door locking-unlocking unit that is arranged outside the vehicle door.

3. The lock device according to claim 1, wherein the lock control unit is configured to
lock the locking subject if the vehicle door is locked when a locking operation is performed on the door locking-unlocking unit that is arranged inside the vehicle, and
unlock the locking subject if the vehicle door is unlocked when an unlocking operation is performed on the door locking-unlocking unit that is arranged inside the vehicle.

4. The lock device according to claim 1, wherein the lock control unit is configured to
lock the locking subject if the vehicle door is locked when a locking operation is performed with a mechanical key on a key cylinder serving as the door locking-unlocking unit that is arranged in the vehicle door, and
unlock the locking subject if the vehicle door is unlocked when an unlocking operation is performed with the mechanical key on the key cylinder.

5. The lock device according to claim 1, wherein the lock control unit is configured to
lock the locking subject if the vehicle door is locked when a locking operation is performed on the door locking-unlocking unit that is arranged on an electronic key, and
unlock the locking subject if the vehicle door is unlocked when an unlocking operation is performed on the door locking-unlocking unit that is arranged on the electronic key.

6. The lock device according to claim 1, wherein the locking subject includes the charge cable.

7. The lock device according to claim 1, wherein the locking subject includes a lid that closes the power port.

8. A controller coupled to a power port lock mechanism to control the power port lock mechanism, wherein the power port lock mechanism locks an power port arranged in a vehicle in response to a power port lock drive signal to restrict removal of a charge cable from the power port or restrict connection of the charge cable to the power port, and the power port lock mechanism unlocks the power port in response to a power port unlock drive signal to permit removal of the charge cable from the power port or permit connection of the charge cable to the power port, the controller comprising:
instructions configured to receive a door lock state signal indicating that a vehicle door is locked, a door unlock state signal indicating that the vehicle door is unlocked, a vehicle door locking operation notification signal, and a vehicle door unlocking operation notification signal;
instructions configured to provide the power port lock mechanism with the power port lock drive signal when the door lock state signal and the vehicle door locking operation notification signal, which follows the door lock state signal, are received; and
instructions configured to provide the power port lock mechanism with the power port unlock drive signal when the door unlock state signal and the vehicle door unlocking operation notification signal, which follows the door unlock state signal, are received.

9. An electronic key system comprising:
an electronic key that performs wireless communication;
a verification ECU that verifies the electronic key through wireless communication;
a power port lock mechanism responsive to a power port lock drive signal and a power port unlock drive signal, wherein the power port lock mechanism locks a power port arranged in a vehicle in accordance with the power port lock drive signal to restrict removal of a charge cable from the power port or restrict connection of the charge cable to the power port, and the power port lock mechanism unlocks the power port in accordance with the power port unlock drive signal to permit removal of the charge cable from the power port or permit connection of the charge cable to the power port; and
a controller coupled to the power port lock mechanism to control the power port lock mechanism, wherein the controller includes
instructions configured to receive a door lock state signal indicating that a vehicle door is locked, a door unlock state signal indicating that the vehicle door is unlocked, a vehicle door locking operation notification signal, and a vehicle door unlocking operation notification signal,
instructions configured to provide the power port lock mechanism with the power port lock drive signal when, after the verification ECU verifies the electronic key, the door lock state signal and the vehicle door locking operation notification signal, which follows the door lock state signal, are received, and
instructions configured to provide the power port lock mechanism with the power port unlock drive signal when, after the verification ECU verifies the electronic key, the door unlock state signal and the vehicle door unlocking operation notification signal, which follows the door unlock state signal, are received.
